(19) United States
(12) Patent Application Publication
(10) Pub. No.: US 2025/0227651 A1
(43) Pub. Date: Jul. 10, 2025

(54) RELAY AND REMOTE SL UE POSITIONING CONFIGURATION THROUGH PAGING TRANSFER METHOD

(71) Applicant: QUALCOMM Incorporated, San Diego, CA (US)

(72) Inventors: Mukesh KUMAR, Hyderabad (IN); Alexandros MANOLAKOS, Athens (GR); Srinivas YERRAMALLI, San Diego, CA (US)

(21) Appl. No.: 18/847,117

(22) PCT Filed: Mar. 17, 2023
(86) PCT No.: PCT/US2023/015573

§ 371 Date: Sep. 13, 2024

(30) Foreign Application Priority Data
May 13, 2022 (GR) 20220100391

(51) Int. Cl. H04W 64/00; H04W 68/00; H04W 88/04; H04W 92/18

(52) U.S. Cl. CPC H04W 64/00; H04W 68/00; H04W 88/04; H04W 92/18

(57) ABSTRACT

In some implementations, a relay user equipment (UE) may obtain positioning capability information from one or more remote UEs, wherein, for each remote UE of the one or more remote UEs, the positioning capability information is indicative of at least one capability of the respective remote UE for performing sidelink (SL) positioning. The relay UE may obtain positioning configuration information for conducting the SL positioning session. The relay UE may send, to the one or more remote UEs, the positioning configuration information, wherein the relay UE sends the positioning configuration information during one or more paging occasions (POs) of the one or more remote UEs.

### RELATED APPLICATIONS

This application claims the benefit of Greek application No. 20220100391, filed May 13, 2022, entitled “RELAY AND REMOTE SL UE POSITIONING CONFIGURATION THROUGH PAGING TRANSFER METHOD”, which is assigned to the assignee hereof, and incorporated herein in its entirety by reference.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

In a data communication network, various positioning techniques can be used to determine the position of a mobile device (referred to herein as a UE). Some of these positioning techniques may involve determining distance and/or angular information of RF signals received by one or more other UEs communicatively coupled with the data communication network. In a fifth generation (5G) wireless standard, referred to as New Radio (NR), direct communication between UEs (including the transmission of RF signals for positioning) may be referred to as sidelink (SL). A positioning session between UEs may be conducted to perform positioning measurements using SL RF signals, and UEs can coordinate such SL positioning sessions to ensure efficient use of bandwidth and other wireless resources.

### BRIEF SUMMARY

An example method at a relay user equipment (UE) of enabling a sidelink (SL) positioning session using paging transfer, according to this disclosure, may comprise obtaining, at the relay UE, positioning capability information from one or more remote UEs, wherein, for each remote UE of the one or more remote UEs, the positioning capability information is indicative of at least one capability of the respective remote UE for performing SL positioning. The method also may comprise obtaining, at the relay UE, positioning configuration information for conducting the SL positioning session. The method also may comprise sending, from the relay UE to the one or more remote UEs, the positioning configuration information, wherein the relay UE sends the positioning configuration information during one or more paging occasions (POs) of the one or more remote UEs.

An example method at a location server of enabling a sidelink (SL) positioning session using paging transfer, according to this disclosure, may comprise receiving, at the location server from a relay user equipment (UE), positioning capability information of one or more remote UEs, wherein, for each remote UE of the one or more remote UEs, the positioning capability information is indicative of at least one capability of the respective remote UE for performing SL positioning. The method also may comprise determining positioning configuration information for conducting the SL positioning session based at least in part on the positioning capability information. The method also may comprise sending, to the relay UE from the location server, the positioning configuration information, wherein the location server sends the positioning configuration information in a paging request.

An example relay user equipment (UE) for enabling a sidelink (SL) positioning session using paging transfer, according to this disclosure, may comprise a transceiver, a memory, one or more processors communicatively coupled with the transceiver and the memory, wherein the one or more processors are configured to obtain, via the transceiver, positioning capability information from one or more remote UEs, wherein, for each remote UE of the one or more remote UEs, the positioning capability information is indicative of at least one capability of the respective remote UE for performing SL positioning. The one or more processors further may be configured to obtain positioning configuration information for conducting the SL positioning session. The one or more processors further may be configured to send, via the transceiver to the one or more remote UEs, the positioning configuration information, wherein the relay UE sends the positioning configuration information during one or more paging occasions (POs) of the one or more remote UEs.

An example location server for enabling a sidelink (SL) positioning session using paging transfer, according to this disclosure, may comprise a transceiver, a memory, one or more processors communicatively coupled with the transceiver and the memory, wherein the one or more processors are configured to receive, via the transceiver from a relay user equipment (UE), positioning capability information of one or more remote UEs, wherein, for each remote UE of the one or more remote UEs, the positioning capability information is indicative of at least one capability of the respective remote UE for performing SL positioning. The one or more processors further may be configured to determine positioning configuration information for conducting the SL positioning session based at least in part on the positioning capability information. The one or more processors further may be configured to send, via the transceiver to the relay UE, the positioning configuration information, wherein the relay UE sends the positioning configuration information in a paging request.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIGS. 3A-3C are simplified diagrams of scenarios in which sidelink (SL) positioning may be used to determine the position of a target user equipment (UE).

FIG. 4 is a diagram that illustrates a scenario in which relay paging is used.

FIG. 5 is a diagram that illustrates a scenario in which principles of the relay paging mechanism (e.g., of FIG. 4) can be expanded to positioning, according to some embodiments.

FIG. 6 is a diagram illustrating frequency usage of relay and remote UEs in three different example cases.

FIG. 7 is a call-flow diagram illustrating a first example process of providing positioning configuration through a paging transfer method described herein, according to an embodiment

FIG. 8 is a call-flow illustrating a second example process of providing positioning configuration through a paging transfer method described herein, according to an embodiment

FIG. 9 is a call-flow illustrating a third example process of providing positioning configuration through a paging transfer method described herein, according to an embodiment.

FIG. 10 is a flow diagram of a method at a relay UE of enabling a SL positioning session using paging transfer, according to an embodiment.

FIG. 11 is a flow diagram of a method at a location server UE of enabling a SL positioning session using paging transfer, according to an embodiment.

FIG. 12 is a block diagram of an embodiment of a UE, which can be utilized in embodiments as described herein.

FIG. 13 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Position determination of a UE may be based at least in part on measurements of signals transmitted and/or received by the UE via sidelink (SL). In some instances, it may be desirable to determine the position and/or perform these signal measurements by remote UEs that are not actively connected to the network, but which are still communicatively linked to the network via a relay UE and which may be contacted via a paging mechanism implemented by the network. Embodiments herein utilize this paging mechanism to relay positioning information to enable the relay and remote UEs to conduct positioning without a separate discovery process. Additional details regarding such embodiments are provided after a discussion of relevant technology.

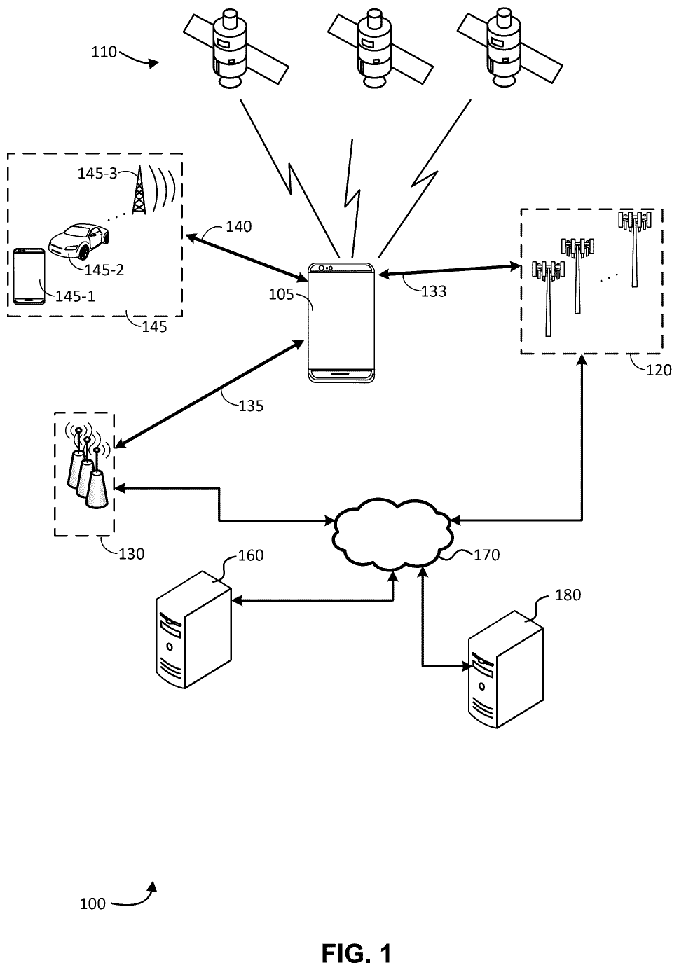

FIG. 1 is a simplified illustration of a positioning system 100 in which a mobile device 105, location server 160, and/or other components of the positioning system 100 can use the techniques provided herein for providing SL positioning configuration through paging transfer for positioning of the mobile device 105, according to an embodiment. The techniques described herein may be implemented by one or more components of the positioning system 100. The positioning system 100 can include: a mobile device 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additional details regarding particular location estimation techniques are discussed hereafter.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network. In a wireless cellular network (e.g., LTE or 5G), the mobile device 105 may be referred to as a user equipment (UE)

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the mobile device 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for Non-Terrestrial Network (NTN)-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning.

The location server 160 may comprise a server and/or other computer system configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other mobile devices communicatively coupled with a cellular or other mobile network (e.g., network 170). When one or more other mobile devices 145 are used in the position determination of a particular mobile device 105, the mobile device 105 for which the position is to be determined may be referred to as the “target mobile device,” and each of the other mobile devices 145 used may be referred to as an “anchor mobile device.” (In a cellular/mobile broadband network, the terms “anchor UE” and “target UE” may be used.) For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., mobile device 105) may be facilitated using measurements from one or more anchor devices (e.g., mobile devices 145).

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another mobile device) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium, or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

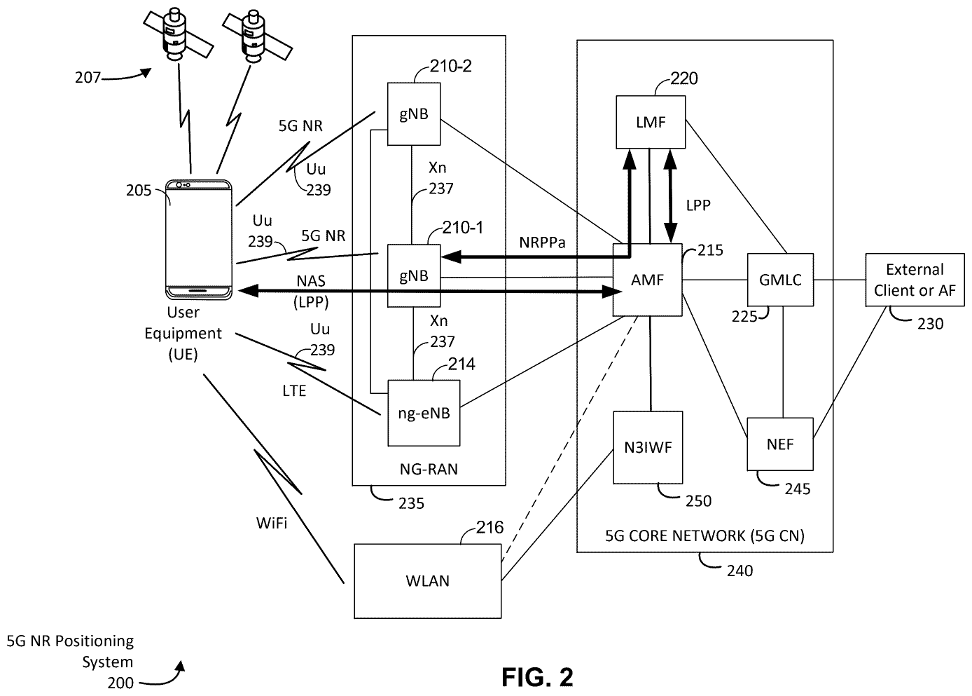

FIG. 2 shows a diagram of a 5G NR positioning system 200, illustrating an embodiment of a positioning system (which may correspond to at least a portion of a larger positioning system as described herein, such as the positioning system 100 of FIG. 1) implementing 5G NR. The 5G NR positioning system 200 may be configured to determine the location of a user equipment (UE) 205 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations described elsewhere herein, and the WLAN 216 may correspond with one or more access points described elsewhere herein. Optionally, the 5G NR positioning system 200 additionally may be configured to determine the location of a UE 205 by using an LMF 220 (which may correspond with a location server as described elsewhere herein) to implement the one or more positioning methods. Here, the 5G NR positioning system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 207. As previously indicated, satellites 207 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 207 may comprise NTN satellites that may be communicatively coupled with the LMF 220 and may operatively function as a TRP (or TP) in the NG-RAN 235. As such, satellites 207 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 207, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like one or more RATs as described elsewhere herein) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to an external client as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations as described elsewhere herein and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., access points, as described elsewhere herein). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

In a 5G NR positioning system 200, positioning methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 207), WLAN, etc.

With a UE-based position method, UE 205 may obtain location measurements (e.g., which may be the same as or similar to location measurements for a UE assisted position method) and may further compute a location of UE 205 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, that is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

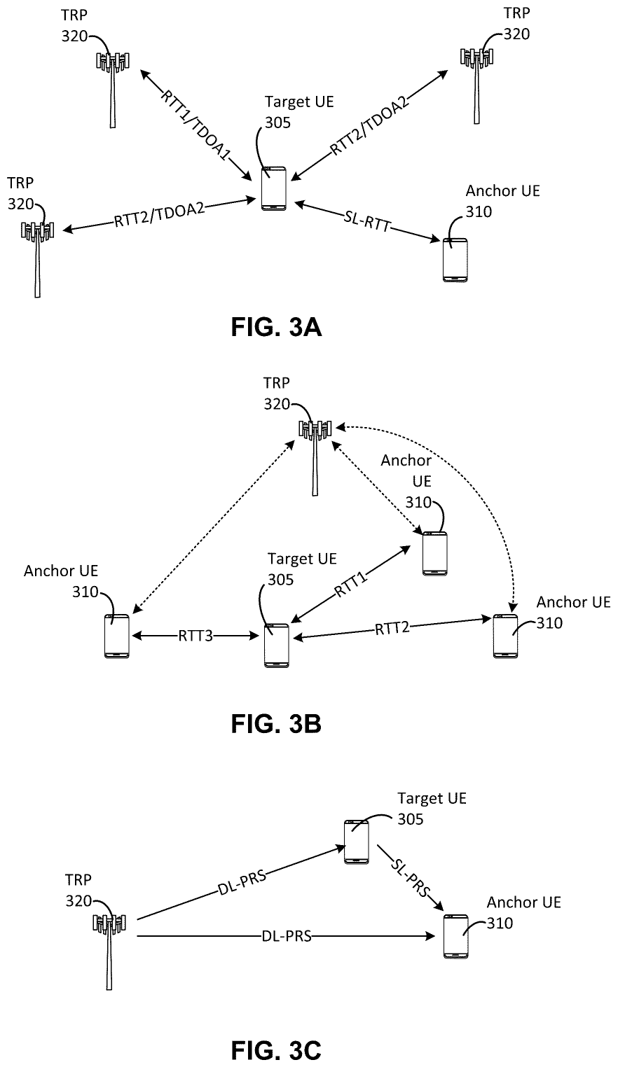

FIGS. 3A-3C are simplified diagrams of scenarios in which sidelink positioning may be used to determine the position of a target UE 305, according to some embodiments. One or more anchor UEs 310 may be used to send and/or receive reference signals via sidelink. As illustrated, positioning may be further determined using one or more base stations 320 (a Uu interface). It will be understood, however, that the signals used for positioning of the UE 305 may vary, depending on desired functionality. More particularly, some types of positioning may utilize signals other than RTT/TDOA as illustrated in FIGS. 3A-3C.

The diagram of FIG. 3A illustrates a configuration in which the positioning of a target UE 305 may comprise RTT and/or TDOA measurements between the target UE 305 and three base stations 320. In this configuration, the target UE 305 may be in coverage range for DL and/or UL signals via Uu connections with the base stations 320. Additionally, the anchor UE 310 at a known location may be used to improve the position determination for the target UE 305 by providing an additional anchor. As illustrated, ranging may be performed between the target UE 305 and anchor UE 310 by taking RTT measurements via the sidelink connection between the target UE 305 and anchor UE 310.

The diagram of FIG. 3B illustrates a configuration in which the positioning of a target UE 305 may sidelink only (SL-only) positioning/ranging. In this configuration, the target UE 305 may perform RTT measurements via sidelink connections between a plurality of anchor UEs 310. In this example, the target UE 305 may not be in UL coverage of the base station 320, and therefore each anchor UE 310 may report RTT measurement information to the network of via a Uu connection between each anchor UE 310 and the base station 320. (In cases in which a UE relays information between a remote UE and a base station, a UE may be referred to as a “relay” UE.) Such scenarios may exist when the target UE 305 has weaker transmission power than anchor UEs 310 (e.g., the target UE 305 comprises a wearable device, and anchor UEs comprise larger cellular phones, IoT devices, etc.). In other scenarios in which the target UE 305 is within UL coverage of the base station 320, the target UE 305 may report RTT measurements directly to the base station 320. In some embodiments, no base station 320 may be used, in which case one of the UEs (e.g., the target UE 305 or one of the anchor UEs 310) may receive RTT measurement information and determine the position of the target UE 305.

The diagram of FIG. 3C illustrates a configuration in which the positioning of a target UE 305 may comprise the target UE 305 and anchor UE 310 receiving a reference signal (DL-PRS) from the base station 320, and the target UE 305 sending a reference signal (SL-PRS) to the anchor UE 310. The positioning of the target UE can be determined based on known positions of the base station 320 and anchor UE 310 and a time difference between a time at which the anchor UE 310 receiving the reference signal from the base station 320 and a time at which the anchor UE 310 receives the reference signal from the target UE 305.

As previously discussed, the use of sidelink positioning (e.g., SL-only or Uu/SL positioning, as illustrated in FIGS. 3A-3C) may utilize a Resource Pool for Positioning (RP-P). RP-P may be conveyed to UEs via a sidelink configuration (e.g., using techniques described hereafter), and may designate particular resource pools for sidelink reference signals in different scenarios. Resource pools comprise a set of resources (e.g., frequency and time resources in in an orthogonal frequency-division multiplexing (OFDM) scheme used by 4G and 5G cellular technologies) that may be used for the transmission of RF signals via sidelink for positioning. Each resource pool may further include a particular subcarrier spacing (SCS), cyclic prefix (CP) type, bandwidth (BW) (e.g., subcarriers, bandwidth part, etc.), time-domain location (e.g., periodicity and slot offset) Resource pools may comprise, for example, Tx resource pools for “Mode 1” sidelink positioning in which sidelink positioning is performed using one or more network-connected UEs, in which case network-based resource allocation may be received by a network-connected UE via a Uu interface with a base station (e.g., via Downlink Control Information (DCI) or Radio Resource Control (RRC)). Tx resource pools for “Mode 2” sidelink positioning in which autonomous resource selection is performed by UEs without network-based resource allocation. Resource pools may further comprise Rx resource pools, which may be used in either Mode 1 or Mode 2 sidelink positioning. Each RP-P configuration may be relayed via a physical sidelink control channel (PSCCH), which may reserve one or more SL-PRS configurations. Each of the one or more SL-PRS configurations of in RP-P may include respective specific physical layer features such as a number of symbols, comb type, comb-offset, number of subchannels, some channel size, and start resource block (RB). The RP-P configuration may further include a sensing configuration, power control, and/or Channel Busy Ratio (CBR).

According to some embodiments, exceptional RP-P can be designated and used in circumstances in which it may not be desirable or possible to perform sidelink positioning via the available resource pools of non-exceptional RP-P for sidelink. Such exceptional cases may include situations similar to those that trigger the use of exceptional resource pools for communication, such as situations in which there may be physical layer problems, before the UE finishes and initiated connection, or during a handover of the UE. As with non-exceptional RP-P for sidelink, exceptional RP-P for sidelink may be configured or preconfigured, and may be allocated by the network or autonomously selected (e.g., used in Mode 1 or Mode 2 sidelink positioning). Further, according to some embodiments, exceptional RP-P may be preconfigured, preloaded, and/or hardcoded into UEs for different geographic regions or areas. Different countries, for example, may designate particular resources for exceptional RP-P in cases of public safety. Exceptional RP-P may be configured via dedicated signaling (e.g., PC5) and/or configured via System Information Block (SIB) via a Uu interface. In some embodiments, the exceptional RP-P may be broadcasted during the positioning session setup phase or discovery phase of a UE. Additionally or alternatively, exceptional RP-P may be assigned or allocated using resource reservation techniques.

Conducting a sidelink positioning session (e.g., in the manner illustrated in FIGS. 3A-3C) in Mode 2 often can be inefficient because a target UE may need to determine which other UEs are nearby and available to act as anchor UEs in the sidelink positioning session. To do so, the target UE may need to perform a discovery procedure, which can introduce latency in the sidelink positioning process. Embodiments described herein may address these and other issues by providing mechanisms that may be used to forgo the need for performing discovery. In particular, embodiments may leverage information and mechanisms used in a cellular network to relay paging to remote UEs (e.g., outside network coverage).

Paging is a mechanism that may be used in a cellular network power savings UE. Paging allows a UE can enter a low power or “sleep” (e.g., RRC idle or inactive mode), then periodically wake up and check for pages from the cellular network, based on a predetermined schedule. A page intended for the UE can identify the UE using an identifier, such as a Radio Network Temporary Identifier (RNTI). If the UE receives a page, it can power up and connect with the cellular network (e.g., enter an RRC connected mode) to communicate data in accordance with the page. The cellular network may send a page to the UE, for example, when the UE is receiving a telephone call and/or in other instances in which the network wants to “push” data to the UE.

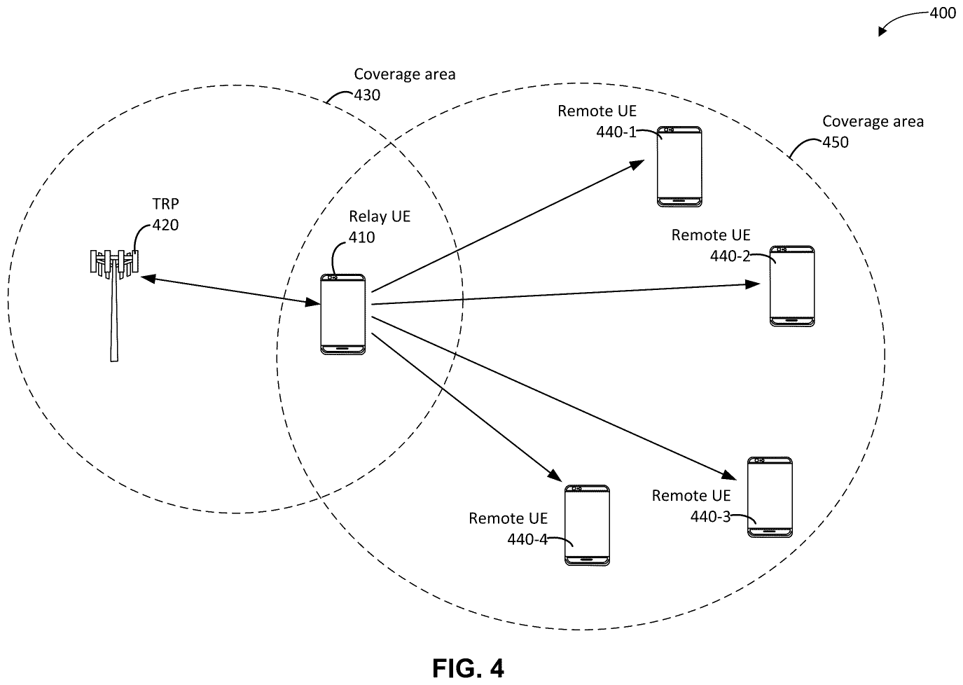

Relay paging as a mechanism that builds on the idea of paging to allow a relay UE to communicate pages to other UEs. Example of this is illustrated in FIG. 4.

FIG. 4 is a diagram that illustrates a scenario 400 in which relay paging is used. In relay paging, pages from a cellular network can be relayed by a relay UE 410, which may be known as a UE-to-network (UE2N) relay. In particular, for a cellular network with number of TRPs (e.g., base stations) including TRP 420, a relay UE 410 within the coverage area 430 of the TRP 420 can be used to a relay pages transmitted by the TRP 420 to one or more remote UEs 440-1, 440-2, 440-3, and 440-4 (collectively and generically referred to herein as remote UEs 440) that are outside the coverage area 430 (and any other TRPs of the cellular network) and are in a sleep (idle/inactive) mode. The relay UE 410 and remote UEs 440 may communicate with each other via direct communication (e.g., device-to-device (D2D) communications, such as sidelink/PC5-RRC signaling) having a separate coverage area 450. The relay UE 410, therefore, is located within both the coverage area 430 of the TRP 420 and the coverage area 450 of the remote UEs 440. Further, the relay UE 410 listens to pages transmitted by the TRP 420 to determine whether the pages for any of the remote UEs 440 (e.g., as identified by their corresponding RNTIs). If so, the relay UE 410 can communicate the page to the respective remote UE(s) 440 based on the schedule(s) of the remote UE(s) 440 for receiving pages, causing the respective remote UE(s) 440 to wake up (e.g., enter an RRC connected mode).

The paging search space (which may be referred to as “pagingSearchSpace” in relevant 3GPP standards), may represent time and/or frequency used by UE to listen for a page. Each instance a page is sent may be referred to as a paging occasion (PO). A particular remote UE 440 may exchange capability information to determine whether a relay UE 410 is capable of monitoring and relaying POs for the particular remote UE 440. This capability may be subject to any POs of the relay UE 410 itself. If the relay UE 410 is incapable of monitoring POs for the particular remote UE 440, the relay UE 410 may inform the network (e.g., via the TRP 420), and the network may modify the paging search space of the particular remote UE 440 to make it receivable by the relay UE 410. Aligning the paging search spaces of the relay UE 410 and one or more remote UEs 440 can help the relay UE 410 save power. Depending on desired functionality, the relay UE 410 may relay the entire page and/or a summary or truncated version thereof.

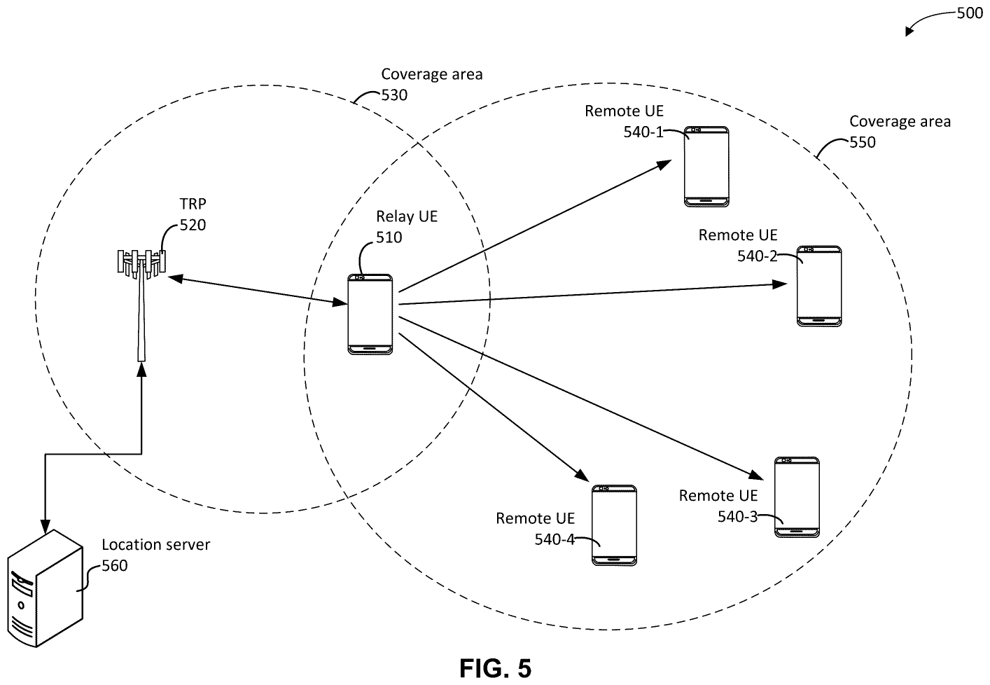

FIG. 5 is a diagram that illustrates a scenario 500 in which principles of the relay paging mechanism (e.g., of FIG. 4) can be expanded to positioning, according to some embodiments. In this scenario 500, components 510-550 correspond with components 410-450 of FIG. 4, and location server 560 may correspond with location server 160 of FIG. 1 and/or LMF 220 of FIG. 2 (e.g., if the cellular network comprises a 5G cellular network). As noted, embodiments may leverage the framework of relay paging to facilitate the determination of anchor UEs for sidelink positioning. This can enable a UE (e.g., a relay UE 510 or remote UE 540) to determine UEs with which to conduct sidelink positioning session much faster than the discovery procedure in sidelink mode 2 operation. Among other things, this can reduce the positioning latency in most cases. If relay UE 510 is connected to the network (e.g., via TRP 520), the location server 560 can determine the configuration and resource pool configuration (e.g., PRS configuration including frequency, timing, etc.) based on sidelink positioning capabilities of remote UEs 540 relayed through the relay UE 510. If disconnected from the network, the relay UE 510 can determine the configuration settings (e.g., rather than the location server 560) based on the sidelink positioning capabilities of the remote UEs 540.

Generally speaking, operating in mode 1 (in which the network coordinates the sidelink positioning session) has a latency advantage over operating on mode 2 (in which UEs coordinate the sidelink positioning session among themselves) because mode 2 involves performing a discovery procedure, as previously noted. Traditionally, remote UEs 540 (e.g., UEs not operating in connected mode) may be incapable of operating in mode 1 for sidelink positioning sessions. This may be illustrated using the two examples that follow.

In a first example, relay UE 510 may determine that it needs to perform a positioning session. Because the relay UE 510 is connected to the network, the TRP 520 and location server 560 will be aware of the positioning capability of relay UE 510. However, the TRP 520 and location server 560 will not be aware of the positioning capability of remote UEs 540. Thus, the relay UE 510 may need to perform positioning in mode 2.

In a second example, a first remote UE 540-1 may determine that it needs to perform the positioning session. The network will not be aware of the positioning capability of the first remote UE 540-1 because it is out of network coverage. Thus, similar to the first example, the first remote UE 540-1 may need to perform positioning in mode 2.

Embodiments herein may be capable of enabling UEs in such examples to operate in mode 1 for sidelink positioning by leveraging the paging relay framework to share positioning-related information. This can allow the network or a UE to determine the configuration and resource pool configuration for the sidelink positioning session without a separate discovery process.

To do this, embodiments can provide for a relay UE (e.g., relay UE 510) that stores the positioning capabilities of one or more remote UEs (e.g., remote UEs 540). According to some embodiments, be capability of each remote UE for performing sidelink positioning may be stored by the relay UE as a respective Boolean flag for the remote UE. (This may be stored by the relay UE, for example, in a similar manner that the relay UE stores paging information for each remote UE.) This positioning capability information may be provided by each remote UE to the relay UE after establishing a sidelink connection. Examples are provided hereafter. According to some embodiments, a maximum number of remote UE for which positioning capability is stored by the relay UE may be defined in an applicable standard (e.g., 3GPP standards for sidelink positioning), or based on the relay UE's capability for storing positioning capability of remote UEs.

According to some embodiments, a relay UE may also send positioning capability information to a location server (e.g., location server 560). That is, in addition to sending its own positioning capability, a relay UE may send capability information of the remote UEs to a location server (e.g., via a base station/TRP). Such functionality may include modifying applicable standards to do so, because traditional 3GPP standards for sidelink positioning may (i) limit the UE to providing its own positioning capability information, and (ii) limit the location server to receiving positioning capability information for a particular UE by the particular UE. Modified 3GPP standards may therefore allow (i) a UE to relay positioning capability information for other UEs, and (ii) a location server to receive positioning capability information of a first UE from a second UE (in particular, receiving positioning capability information of a remote UE from a relay UE). According to some embodiments relay UE may send positioning capability information after receiving the positioning capability information from one or more remote UEs and/or after receiving a request for positioning capability information from the network (e.g., from a base station/TRP and/or LMF).

According to some embodiments, a relay UE and remote UE can support a positioning session paging mechanism, similar to traditional relay paging. That is, a relay UE and remote UE may perform in a similar manner to relay paging, in which each UE searches a search space for a page (waking up to do so, if necessary). The search space for positioning can even use the same search space as that used for paging. In this case, positioning information can be relayed in a page, enabling a relay UE and/or remote UE to participate in a positioning session when indicated to do so in a corresponding page for the relay UE and/or remote UE. According to some embodiments, each UE can have different capabilities for such functionality. For example, a first capability may comprise supporting such positioning session paging when the relay UE is connected to the network (e.g., relay UE 510 is communicatively connected to TRP 520). A second capability may comprise supporting such positioning session paging when the relay UE is out of coverage with respect to the network. A relay UE may continue to provide paging to remote UEs in such circumstances, for example, if the relay UE would like to communicate (e.g., establish an active communication session) with a remote UE. A third capability may comprise supporting both the first capability and the second capability (i.e., when the relay UE is either connected or disconnected from the network). (By definition, remote UEs will always be out of network coverage.)

According to some embodiments, positioning session paging may be enabled by introducing a new paging cause. That is, performing a positioning session can be included, in addition to current causes, in the types of causes for paging remote UEs (e.g., voice call, data, etc.). The positioning session can be conducted to determine the position of a relay UE and/or a remote UE. In some embodiments, a positioning search space may be established for the positioning use case, in a manner similar to the paging search for traditional pages. In such embodiments, the relay UE can read the positioning search space and pass positioning information intended for a remote UE to the respective remote UE, In some embodiments, the positioning search space may be within the active bandwidth part (BWP) used by the relay UE. In some embodiments, the positioning search space may be outside of the active BWP for the relay UE. In some embodiments, the positioning search space may be in different combinations of BWPs for the relay UE.

According to some embodiments, positioning configuration information can be included within a page. That is, similar to a paging and a paging record list for sidelink data, positioning pages can include, for example, a positioning paging record and a positioning paging record list. A paging record list may include the positioning configuration for one or multiple remote UEs. Like pages, positioning configuration information can be specific to a particular relay or remote UE. Positioning configuration information can include relevant information to enable the relay or remote UE to participate in the positioning session. This can include, for example, PRS resources, resources sets, TRPs, and/or other such information regarding resources that may be used by each UE for positioning. Each PRS resource may have a particular bandwidth, comb/symbol information/option (e.g., for symbol usage in an orthogonal frequency division multiplexing (OFDM) communication scheme, such as those used in 4G and 5G cellular/mobile communication networks), starting slot/symbol, repetition, and/or the like.

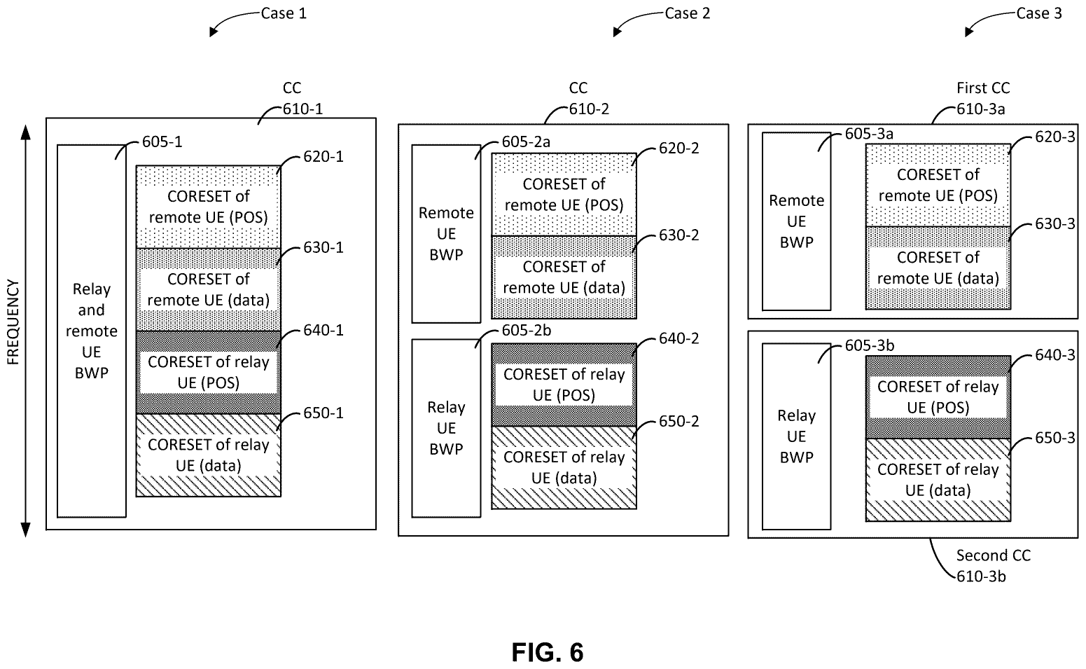

FIG. 6 is a diagram illustrating frequency usage of relay and remote UEs in three different example cases: case 1, case 2, and case 3. Different UEs may have different capabilities for supporting each of the cases. For example, some UEs may be capable of supporting only one case (e.g., case number one, case 2, or case 3), others may be capable of supporting two cases, and yet others may be capable of supporting all three cases.

Here, case 1 comprises the relay and remote UEs operating in a common BWP 605-1 within a common component carrier (CC) 610-1. That is, the control resource sets (CORESETs) comprising sets of time and frequency resources and parameters used to carry control information (which may be defined in resource blocks (RBs) and/or resource elements (RE) in the OFDM communication scheme used in the cellular/mobile communication network) used for positioning and data by both remote and relay UEs are within the common BWP 605-1 and CC 610-1. As illustrated, frequency bands used positioning CORESET set of the remote UE 620-1, the data CORESET other remote UE 630-1, the positioning CORESET of the relay UE 640-1, and the data CORESET of the relay UE 650-1, each fall within the common relay and remote UE BWP 605-1 and common CC 610-1.

Case 2 illustrates a case in which the relay UE and remote UE use different BWPs. That is, the Uu interface used by the relay UE and the SL/PC5 interface used by the remote UE may operate on different BWPs. As shown in FIG. 6, case 2 has two BWPs: a remote UE BWP 605-2a and a relay UE BWP 605-2b. Accordingly, the positioning CORESET of the remote UE 620-2 and data CORESET of the remote UE 630-2 are communicated within the remote UE BWP 605-2a, and the positioning CORESET of the relay UE 640-2 and data CORESET of the relay UE 650-2 are communicated within the relay UE BWP 605-2b. In case 2, the remote UE BWP 605-2a and the relay UE BWP 605-2b are both within a common CC 610-2.

Case 3 illustrates a scenario similar to case 2. Here, however, different BWPs parts within different CCs. More specifically, case 3 has two BWPs: a remote UE BWP 605-3a and a relay UE BWP 605-3b. The positioning CORESET of the remote UE 620-3 and data CORESET of the remote UE 630-3 are communicated within the remote UE BWP 605-3a, and the positioning CORESET of the relay UE 640-3 and data CORESET of the relay UE 650-3 are communicated within the relay UE BWP 605-3b. In contrast to case 2, however, the remote UE BWP 605-3a is within a first CC 610-3a and the relay UE BWP 605-3b is within a second CC 610-3b.

As noted, different UEs may be capable of supporting different cases. Because case 2 and case 3 require a relay UE to tune to a separate BWP (and, in case 3, a separate CC), constraints such as power, timing for re-tuning, etc. may act as limits to the relay UE in reading paging and positioning search spaces. Nonetheless, as previously noted, some UEs may be capable of performing the functionality of the relay UE in all three cases. These capabilities can be shared with one or more remote UEs and/or the network (e.g., a base station/TRP and/or location server).

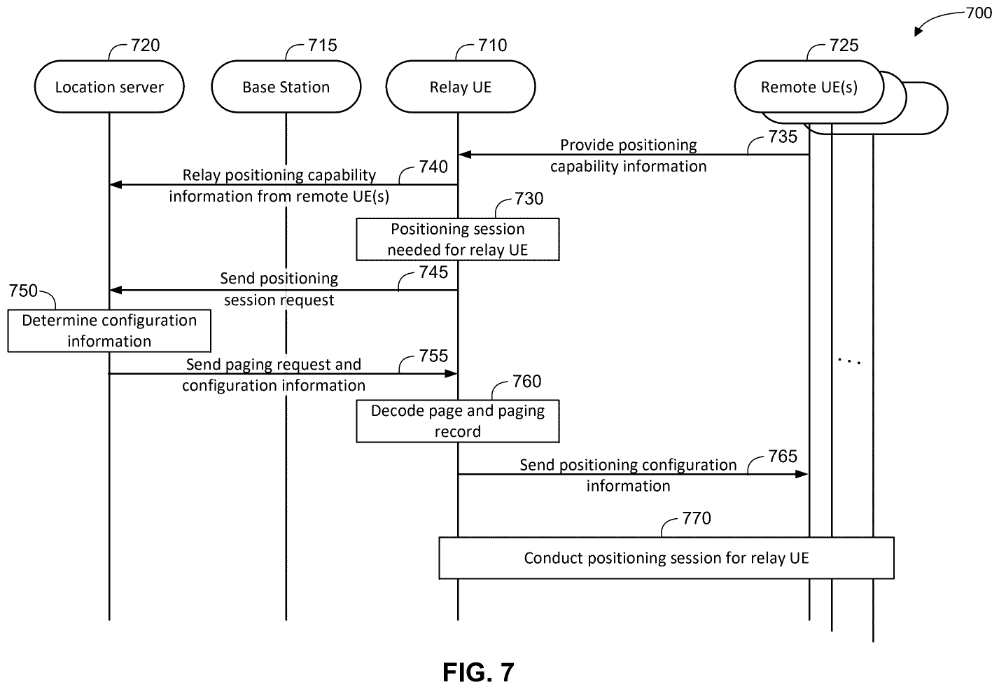

FIG. 7 is a call-flow diagram illustrating a first example process 700 of providing positioning configuration through a paging transfer method as previously described, according to an embodiment. In this example, a relay UE 710 determines that it needs to perform a positioning session, as indicated at block 730. This determination may be made, for instance, based on an application executed by the UE (e.g., a navigation application), user input, a request received by the UE from another device, or combination thereof. As noted, the base station 715 (e.g., the serving base station of the relay UE 710) and location server 720 (e.g., an LMF in a 5G network) traditionally may be aware of the positioning capabilities of the relay UE 710, but unaware of positioning capabilities of one or more remote UEs 725 outside the coverage of the network of the base station 715 and location server 720. Thus, the relay UE 710 traditionally may need to perform a positioning session in mode 2 which, as previously discussed, may result in delays for positioning due to performing a discovery procedure.

However, in accordance with process 700, positioning capability information for the remote UE(s) 725 can be propagated to the relay UE 710 and network beforehand. That is, as indicated by arrow 735, the remote UE(s) 725 can provide positioning capability information, as indicated at arrow 735, which can then relay the positioning capability information of the remote UE(s) 725 to the location server 720. This way, when the relay UEs 710 determines that it needs a positioning session (again, as indicated at block 730) and sends a corresponding positioning session request (indicated by arrow 745) to the location server 720, the location server 720 can then determine a configuration information for the position session based on positioning capabilities of both the relay UE 710 and the remote UE(s) 725. The determination of this configuration information is indicated at block 750. According to some embodiments, positioning capability information of the relay UE 710 may be previously provided to the location server 720 via traditional means. Additionally or alternatively, the relay UE 710 may include its positioning capability information when relaying positioning capability information from the remote UE(s) 725 at arrow 740. As previously noted, the relay UE 710 may provide the positioning capability information of the remote UE(s) 725 responsive to a request from the location server 720 (not shown) and/or responsive to one or more other triggers (e.g., receipt of the positioning capability information, a timer/schedule to send the information, etc.). For their part, remote UEs 725 may provide positioning capability information at any of a variety of times, such as when establishing sidelink/PC5 communications with the relay UE 710, when moving to a different location, when providing the relay UE 710 with paging information, or any combination thereof.

After the location server determines the configuration information for the positioning session, it can then send a paging requests and configuration information for the relay UE 710, as indicated at arrow 755. As discussed, configuration information can include timing, frequency, and/or other information used by UEs to perform the positioning session. As previously noted, configuration information may be included in a paging request. For example, a positioning paging record (e.g., “PosPagingRecord”) included in the paging request may define a positioning configuration. The relay UE 710 may then decode the page and paging record for the remote UE(s) 725, indicated by block 760, and send the decoded positioning configuration information to the remote UE(s) 725, as indicated at arrow 765. In some embodiments, the relay UE 710 may broadcast this information to the remote UE(s) 725. In some embodiments, the relay UE may send one or more unicast messages to each of the remote UE(s) 725. Additionally or alternatively, as previously indicated, the relay UE 710 may decode a portion of the paging record and send a summary and/or forward the applicable portions of the page/paging record to each respective remote UE 725. After the positioning configuration information is sent, the relay UE 710 and the remote UE(s) 725 can conduct the positioning session, as indicated at block 770. To determine the position of the relay UE 710, measurement and/or other information related to the positioning session can be passed between UEs and/or relayed to the location server 720 via the relay UE 710 in accordance with traditional positioning techniques. Thus, the positioning session can effectively operate in a mode 2 sidelink configuration.

It can be noted that a subset of UEs for which positioning information is known and included in a positioning paging record may be used for a positioning session. For example, in positioning paging record, a location server may provide the configuration information for M number of UEs. However, the location server may use only N UEs (where N<M) for a positioning session. The number of UEs used in a positioning session may vary on the environment (some environments may use more or fewer UEs than other environments to get a confident position fix for a UE).

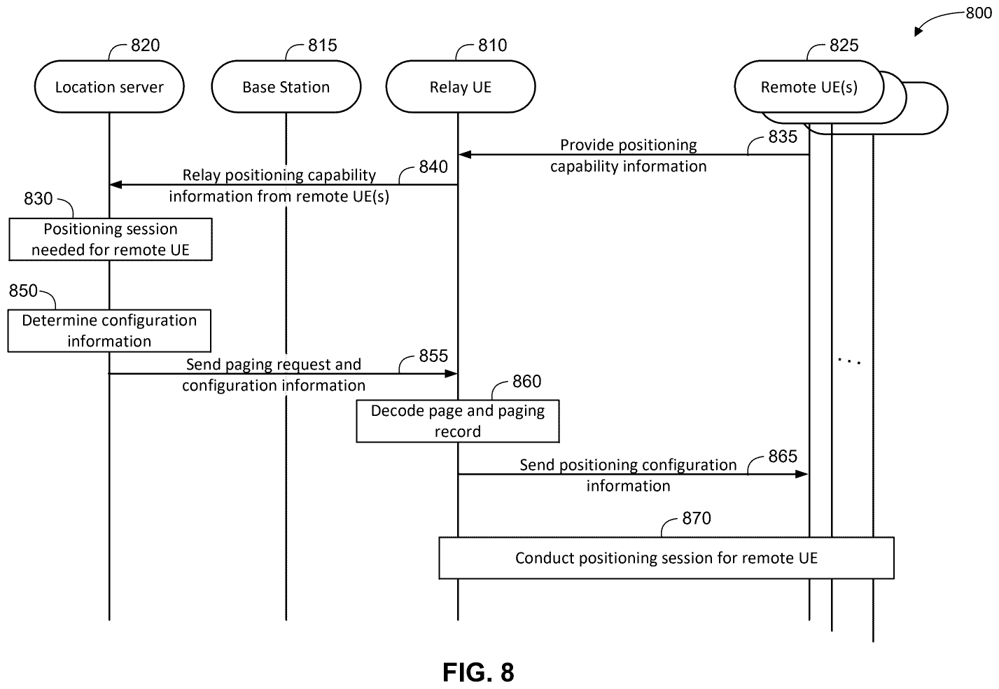

FIG. 8 is a call-flow illustrating a second example process 800 of providing positioning configuration through a paging transfer method as previously described, according to an embodiment. In contrast to the relay UE-initiated example in FIG. 7, this example illustrates a location server-initiated process for determining the position of a particular remote UE (of the remote UE(s) 825). As can be seen, operations in the example process 800 generally reflect those in the process 700 of FIG. 7, and thus these operations may be carried out in the manner of corresponding operations previously described with respect to FIG. 7. Here, however, the location server 820 may determine that a positioning session is needed for the particular remote UE, as indicated at block 830. This determination may be made, for example, responsive to a request internal to the cellular/mobile communication network (e.g., a positioning function within the network), a request from an external device or entity (e.g., e911 request), or a combination thereof. Accordingly, it can determine the configuration information, as indicated at block 850. Again, the paging framework can be used to initially obtained the positioning capability information of the remote UE(s) 825, as well as propagate configuration information back to the relay UE 810 and the remote UE(s) 825.

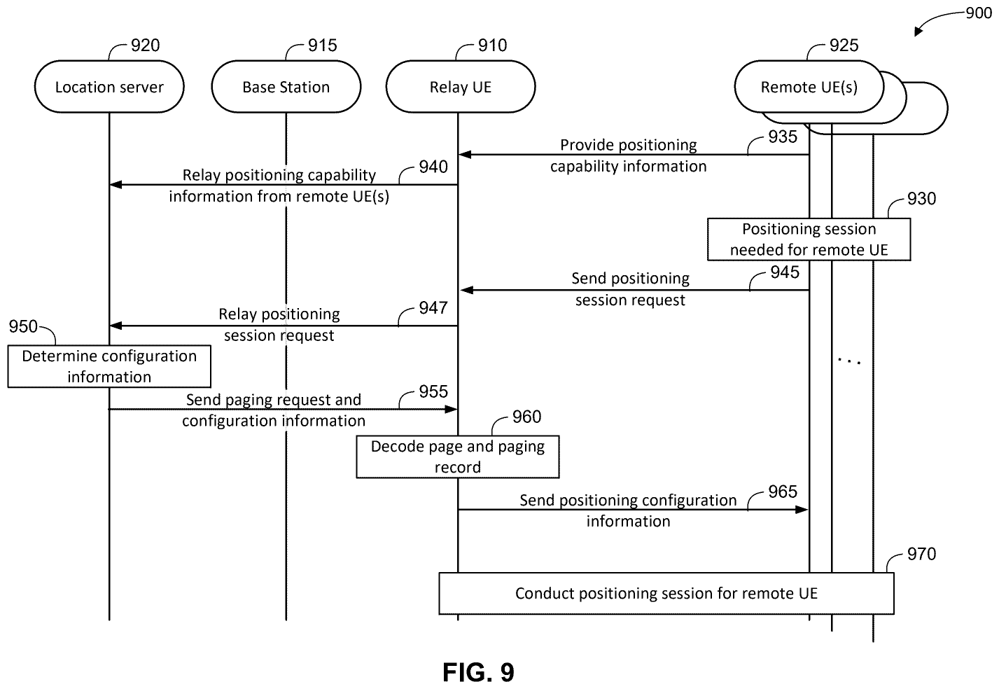

FIG. 9 is a call-flow illustrating a third example process 900 of providing positioning configuration through a paging transfer method as previously described, according to an embodiment. Similar to the relay UE-initiated example in FIG. 7, this example illustrates a UE-initiated positioning process. As can be seen, operations in the example process 800 generally reflect those in the process 700 of FIG. 7, and thus these operations may be carried out in the manner of corresponding operations previously described with respect to FIG. 7. Here, however, it is a particular remote UE (of the remote UE(s) 925) that determined a positioning session is needed for the particular remote UE, as indicated at block 930. Similar to the process 700 of FIG. 7, this determination may be made, for instance, based on an application executed by the particular remote UE (e.g., a navigation application), user input, a request received by the UE from another device, or combination thereof. The particular remote UE can then send a positioning session request to the relay UE 910, as indicated at arrow 945, which relays the positioning session request to the location server, as indicated at arrow 947. Similar to the processes illustrated in FIGS. 7 and 8, the location server 920 than can determine the configuration information, as indicated at block 950. Again, the paging framework can be used to initially obtained the positioning capability information of the remote UE(s) 925, as well as propagate configuration information back to the relay UE 910 and the remote UE(s) 925.

According to some embodiments, the particular remote UE can specify a time at which to conduct the positioning session. That is, upon determining a positioning session is needed, the particular remote UE can also determine a future time T at which the positioning session is needed. This time T can be included in the positioning session request (arrow 945) and relayed (at arrow 947) to the location server 920. That way, the location server 920 can send the paging request (arrow 955) at time T, as requested by the particular remote UE requesting the positioning session.

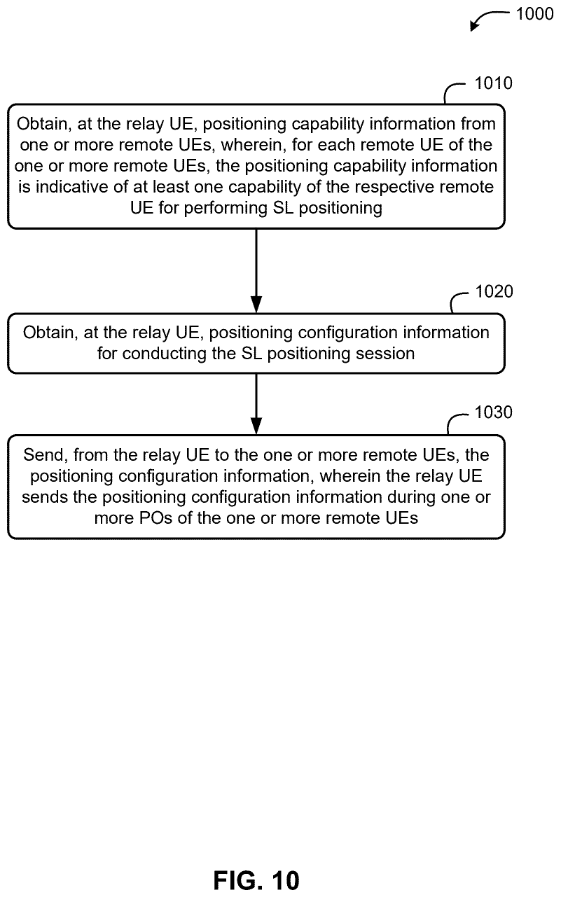

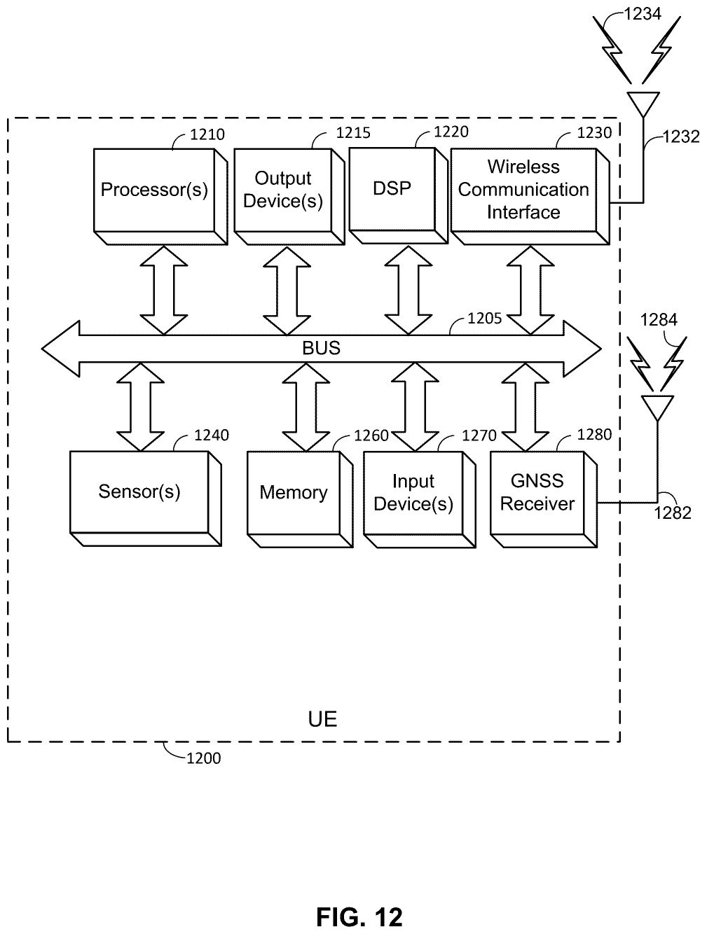

FIG. 10 is a flow diagram of a method 1000 at a relay UE of enabling a SL positioning session using paging transfer, according to an embodiment. Means for performing the functionality illustrated in one or more of the blocks shown in FIG. 10 may be performed by hardware and/or software components of a UE. Example components of a UE are illustrated in FIG. 12, which is described in more detail below.

At block 1010, the functionality comprises obtaining, at the relay UE, positioning capability information from one or more remote UEs, wherein, for each remote UE of the one or more remote UEs, the positioning capability information is indicative of at least one capability of the respective remote UE for performing SL positioning. This can include, for example, capabilities for performing positioning-related measurements (e.g., ToA, RSTD, RSRP, RTT, TDOA, AoA, etc.); positioning-related QoS, accuracy, and/or granularity capabilities; capabilities with regard to timing and/or frequency; or combination thereof. As previously noted, this information may be obtained by the relay UE from the one or more remote UEs. The one or more remote UEs may send this information based on one or more triggers, such as a predefined schedule or periodicity, a triggering event (e.g., movement from a previous location beyond a threshold distance, the elapsing of a predetermined timer, upon establishing and SL communication link with the relay UE, or combination thereof). According to some embodiments, the method 1000 may further comprise storing the positioning capability information with the relay UE. This can enable, for example, the UE to provide the positioning capability information at some later time or use the positioning capability information to determine positioning configuration information for the SL positioning session. According to some embodiments, the number of remote UEs for which the relay UE can store positioning configuration information may be limited. This limit may be defined by governing specification, assigned by a location server or other device, determined by the relay UE itself, or a combination thereof. As such, according to some embodiments of the method 1000, a number of the one or more remote UEs may be less than a predetermined maximum number of remote UEs for which the relay UE is configured to store positioning capability information.

Means for performing functionality at block 1010 may comprise a bus 1205, processor(s) 1210, DSP 1220, wireless communication interface 1230, sensors 1240, memory 1260, and/or other components of a UE 1200, as illustrated in FIG. 12 and described hereafter.

At block 1020, the functionality comprises obtaining, at the relay UE, positioning configuration information for conducting the SL positioning session. As previously noted, the relay UE may obtain such positioning configuration information by determining the positioning configuration information itself (e.g., based on its positioning capability information and the positioning capability information of the one or more remote UEs) or by receiving the positioning configuration information from a separate device, such as a location server.

The method 1000 may include one or more additional functions in embodiments in which a location server determines the positioning configuration information. Such embodiments may include, for example, sending, from the relay UE to a location server, the positioning capability information for the one or more remote UEs. As noted, in such embodiments, obtaining positioning configuration information may comprise receiving the positioning configuration information from the location server. In such embodiments, sending the positioning capability information may be responsive to receiving a request, at the relay UE from the location server, for the positioning capability information.

As previously described, in some embodiments, receiving the positioning configuration information from the location server may comprise receiving the positioning configuration information in a paging request. In some embodiments, the paging request may be received in a paging search space for positioning. The paging search space for positioning may be within an active bandwidth part (BWP) of the relay UE; outside the active BWP of the relay UE but within the same component carrier (CC) of the active BWP of the relay UE; or outside the active BWP of the relay UE and in a separate CC from the CC of the active BWP of the relay UE. In some embodiments, the paging request comprises a positioning paging record and a positioning paging record list.

As described in the examples above, the SL positioning session may be to determine the position of a target UE comprising the relay UE or a remote UE. In such instances, the target UE may initiate the SL positioning session. Accordingly, in some embodiments of the method 1000, the SL positioning session is to determine a location of the relay UE. In such instances the method 1000 may further comprise determining at the relay UE to initiate the SL positioning session, and prior to obtaining the positioning configuration information, sending a positioning session request from the relay UE to the location server. In some embodiments, the SL positioning session is to determine a location of a particular remote UE of the one or more remote UEs. In such instances, the method 1000 may further comprise, prior to obtaining the positioning configuration information, receiving a positioning session request at the relay UE from the particular remote UE and sending the positioning session request from the relay UE to the location server.

Means for performing functionality at block 1020 may comprise a bus 1205, processor(s) 1210, DSP 1220, wireless communication interface 1230, sensors 1240, memory 1260, and/or other components of a UE 1200, as illustrated in FIG. 12 and described hereafter.

At block 1030, the functionality comprises sending, from the relay UE to the one or more remote UEs, the positioning configuration information, wherein the relay UE sends the positioning configuration information during one or more paging occasions (POs) of the one or more remote UEs. Again, the positioning configuration information for a given remote UE may be included in a special positioning paging record, which may be passed on by the relay UE in its entirely or summarized/truncated by the relay UE. As indicated in the previously-described embodiments, the positioning session can then be conducted among the relay UE and one or more remote UEs in accordance with the positioning configuration information.

Means for performing functionality at block 1030 may comprise a bus 1205, processor(s) 1210, DSP 1220, wireless communication interface 1230, sensors 1240, memory 1260, and/or other components of a UE 1200, as illustrated in FIG. 12 and described hereafter.

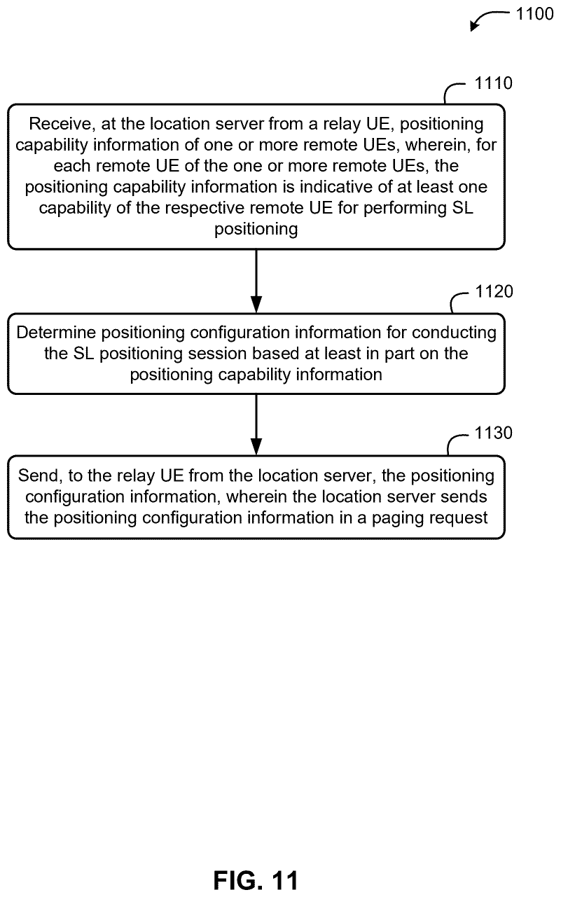

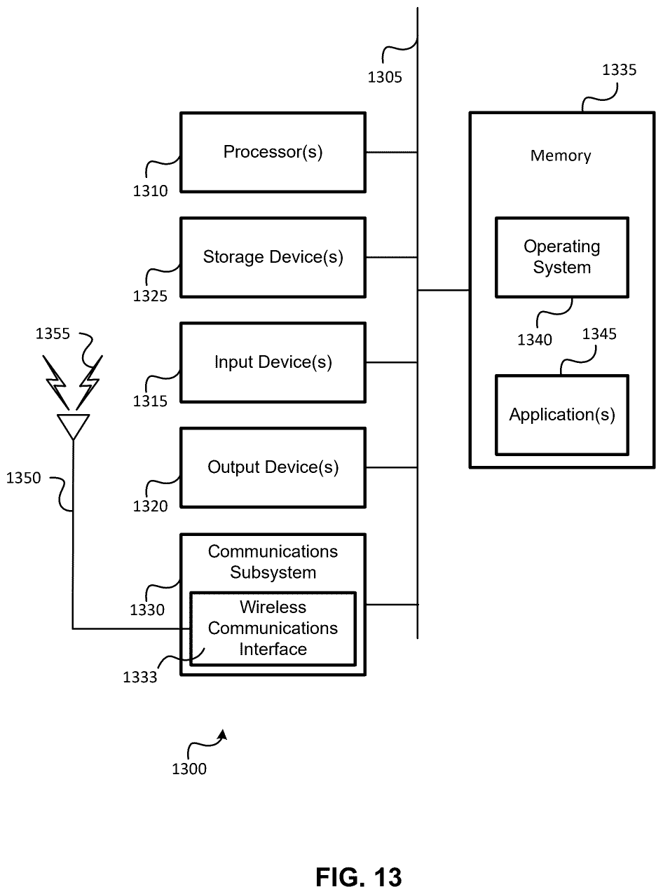

FIG. 11 is a flow diagram of a method 1100 at a location server UE of enabling a SL positioning session using paging transfer, according to an embodiment. Means for performing the functionality illustrated in one or more of the blocks shown in FIG. 11 may be performed by hardware and/or software components of the computer server or other computer system, for example. Example components of a computer system are illustrated in FIG. 13, which is described in more detail below.

At block 1110, the functionality comprises receiving, at the location server from a relay UE, positioning capability information of one or more remote UEs, wherein, for each remote UE of the one or more remote UEs, the positioning capability information is indicative of at least one capability of the respective remote UE for performing SL positioning. Again, capabilities can include, for example, capabilities for performing positioning-related measurements (e.g., ToA, RSTD, RSRP, RTT, TDOA, AoA, etc.); positioning-related QoS, accuracy, and/or granularity capabilities; capabilities with regard to timing and/or frequency; or combination thereof. As indicated in the previously-described embodiments, this information may be obtained by the relay UE from the one or more remote UEs and passed by the relay UE to the location server. In some embodiments, the relay UE may also provide its positioning capability information in the same manner as it provides the positioning capability information of the one or more remote UEs. As previously noted, the relay UE may provide this information in response to a request from the location server. As such, some embodiments of the method 1100 may further comprise, prior to receiving the positioning capability information, send a request to the relay UE from the location server for the positioning capability information.

Means for performing functionality at block 1110 may comprise a bus 1305, processor(s) 1310, DSP 1320, communications subsystem 1330, memory 1335, and/or other components of a computer system 1300, as illustrated in FIG. 13 and described hereafter.

At block 1120, the functionality comprises determining positioning configuration information for conducting the SL positioning session based at least in part on the positioning capability information. Again, location server can coordinate an SL positioning session based on the various capabilities of the relay UE and one or more remote UEs. Means for performing functionality at block 1120 may comprise a bus 1305, processor(s) 1310, DSP 1320, communications subsystem 1330, memory 1335, and/or other components of a computer system 1300, as illustrated in FIG. 13 and described hereafter.

At block 1130, the functionality comprises sending, to the relay UE from the location server, the positioning configuration information, wherein the location server sends the positioning configuration information in a paging request. According to some embodiments, the paging request may be sent in a paging search space for positioning. The paging search space for positioning may be within an active bandwidth part (BWP) of the relay UE, outside the active BWP of the relay UE but within the same component carrier (CC) of the active BWP of the relay UE, or outside the active BWP of the relay UE and in a separate CC from the CC of the active BWP of the relay UE. Again, as previously noted, according to some embodiments, the paging request may comprise a positioning paging record and a positioning paging record list.

Means for performing functionality at block 1130 may comprise a bus 1305, processor(s) 1310, DSP 1320, communications subsystem 1330, memory 1335, and/or other components of a computer system 1300, as illustrated in FIG. 13 and described hereafter.

FIG. 12 is a block diagram of an embodiment of a UE 1200, which can be utilized as described herein above (e.g., in association with FIGS. 1-11). For example, the UE 1200 can perform one or more of the functions of the method shown in FIG. 10 and/or the more general functionality of a relay UE or remote UE as described herein. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 12.

The UE 1200 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The UE 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1200 to communicate with other devices as described in the embodiments above. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 1200 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1200 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 1200, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1210 or DSP 1220.

The UE 1200 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 1200 (and/or processor(s) 1210 or DSP 1220 within UE 1200). In some embodiments, then, such code and/or instructions can be used to configure and/or adapt a general-purpose computer (or other device) to perform one or more operations in accordance with the described methods.

FIG. 13 is a block diagram of an embodiment of a computer system 1300, which may be used, in whole or in part, to provide the functions of one or more network components as described in the embodiments herein (e.g., location server of FIGS. 1, 5, 7-9, and 11). It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner. In addition, it can be noted that components illustrated by FIG. 13 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processor(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1315, which may comprise without limitation a mouse, a keyboard, a camera, a microphone, and/or the like; and one or more output devices 1320, which may comprise without limitation a display device, a printer, and/or the like.

The computer system 1300 may further include (and/or be in communication with) one or more non-transitory storage devices 1325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may comprise wireless communication technologies managed and controlled by a wireless communication interface 1333, as well as wired technologies (such as Ethernet, coaxial communications, universal serial bus (USB), and the like). The wireless communication interface 1333 may comprise one or more wireless transceivers that may send and receive wireless signals 1355 (e.g., signals according to 5G NR or LTE) via wireless antenna(s) 1350. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network, including a User Equipment (UE), base stations and/or other TRPs, and/or any other electronic devices described herein. Hence, the communications subsystem 1330 may be used to receive and send data as described in the embodiments herein.

In many embodiments, the computer system 1300 will further comprise a working memory 1335, which may comprise a RAM or ROM device, as described above. Software elements, shown as being located within the working memory 1335, may comprise an operating system 1340, device drivers, executable libraries, and/or other code, such as one or more applications 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computer systems such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method at a relay user equipment (UE) of enabling a sidelink (SL) positioning session using paging transfer, the method comprising: obtaining, at the relay UE, positioning capability information from one or more remote UEs, wherein, for each remote UE of the one or more remote UEs, the positioning capability information is indicative of at least one capability of the respective remote UE for performing SL positioning; obtaining, at the relay UE, positioning configuration information for conducting the SL positioning session; and sending, from the relay UE to the one or more remote UEs, the positioning configuration information, wherein the relay UE sends the positioning configuration information during one or more paging occasions (POs) of the one or more remote UEs.
Clause 2. The method of clause 1, further comprising storing the positioning capability information with the relay UE.
Clause 3. The method of any one of clauses 1-2 wherein a number of the one or more remote UEs is less than a predetermined maximum number of remote UEs for which the relay UE is configured to store positioning capability information.
Clause 4. The method of any one of clauses 1-3 further comprising sending, from the relay UE to a location server, the positioning capability information for the one or more remote UEs, wherein obtaining positioning configuration information comprises receiving the positioning configuration information from the location server.
Clause 5. The method of clause 4 wherein sending the positioning capability information is responsive to receiving a request, at the relay UE from the location server, for the positioning capability information.
Clause 6. The method of any one of clauses 4-5 wherein receiving the positioning configuration information from the location server comprises receiving the positioning configuration information in a paging request.
Clause 7. The method of clause 6 wherein the paging request is received in a paging search space for positioning.
Clause 8. The method of clause 7 wherein the paging search space for positioning is: within an active bandwidth part (BWP) of the relay UE; outside the active BWP of the relay UE but within the same component carrier (CC) of the active BWP of the relay UE; or outside the active BWP of the relay UE and in a separate CC from the CC of the active BWP of the relay UE.
Clause 9. The method of any one of clauses 6-8 wherein the paging request comprises a positioning paging record and a positioning paging record list.
Clause 10. The method of any one of clauses 4-9 wherein the SL positioning session is to determine a location of the relay UE, and wherein the method further comprises: determining at the relay UE to initiate the SL positioning session; and prior to obtaining the positioning configuration information, sending a positioning session request from the relay UE to the location server.
Clause 11. The method of any one of clauses 4-9 wherein the SL positioning session is to determine a location of a particular remote UE of the one or more remote UEs, and wherein the method further comprises, prior to obtaining the positioning configuration information: receiving a positioning session request at the relay UE from the particular remote UE; and sending the positioning session request from the relay UE to the location server.
Clause 12. A method at a location server of enabling a sidelink (SL) positioning session using paging transfer, the method comprising: receiving, at the location server from a relay user equipment (UE), positioning capability information of one or more remote UEs, wherein, for each remote UE of the one or more remote UEs, the positioning capability information is indicative of at least one capability of the respective remote UE for performing SL positioning; determining positioning configuration information for conducting the SL positioning session based at least in part on the positioning capability information; and sending, to the relay UE from the location server, the positioning configuration information, wherein the location server sends the positioning configuration information in a paging request.
Clause 13. The method of clause 12, further comprising, prior to receiving the positioning capability information, send a request to the relay UE from the location server for the positioning capability information.
Clause 14. The method of any one of clauses 12-13 wherein the paging request is sent in a paging search space for positioning.
Clause 15. The method of clause 14 wherein the paging search space for positioning is: within an active bandwidth part (BWP) of the relay UE; outside the active BWP of the relay UE but within the same component carrier (CC) of the active BWP of the relay UE; or outside the active BWP of the relay UE and in a separate CC from the CC of the active BWP of the relay UE.
Clause 16. The method of any one of clauses 12-15 wherein the paging request comprises a positioning paging record and a positioning paging record list.
Clause 17. A relay user equipment (UE) for enabling a sidelink (SL) positioning session using paging transfer, the relay UE comprising: a transceiver; a memory; and one or more processors communicatively coupled with the transceiver and the memory, wherein the one or more processors are configured to: obtain, via the transceiver, positioning capability information from one or more remote UEs, wherein, for each remote UE of the one or more remote UEs, the positioning capability information is indicative of at least one capability of the respective remote UE for performing SL positioning; obtain positioning configuration information for conducting the SL positioning session; and send, via the transceiver to the one or more remote UEs, the positioning configuration information, wherein the relay UE sends the positioning configuration information during one or more paging occasions (POs) of the one or more remote UEs.
Clause 18. The relay UE of clause 17, wherein the one or more processors are further configured to store the positioning capability information in the memory.
Clause 19. The relay UE of any one of clauses 17-18 wherein a number of the one or more remote UEs is less than a predetermined maximum number of remote UEs for which the relay UE is configured to store positioning capability information.
Clause 20. The relay UE of any one of clauses 17-19 wherein the one or more processors are further configured to send, via the transceiver to a location server, the positioning capability information for the one or more remote UEs, and wherein, to obtain the positioning configuration information, the one or more processors are configured to receive the positioning configuration information from the location server.
Clause 21. The relay UE of clause 20 wherein the one or more processors are configured to send the positioning capability information responsive to receiving a request, from the location server, for the positioning capability information.
Clause 22. The relay UE of any one of clauses 20-21 wherein, to receive the positioning configuration information from the location server, the one or more processors are configured to receive the positioning configuration information in a paging request.
Clause 23. The relay UE of clause 22 wherein the one or more processors are configured to receive the paging request received in a paging search space for positioning.
Clause 24. The relay UE of clause 23 wherein the one or more processors are configured to receive the paging search space for positioning: within an active bandwidth part (BWP) of the relay UE; outside the active BWP of the relay UE but within the same component carrier (CC) of the active BWP of the relay UE; or outside the active BWP of the relay UE and in a separate CC from the CC of the active BWP of the relay UE.
Clause 25. The relay UE of any one of clauses 22-24 wherein the one or more processors are configured to receive, in the paging request, a positioning paging record and a positioning paging record list.
Clause 26. The relay UE of any one of clauses 20-25 wherein the one or more processors are further configured to: determine to initiate the SL positioning session; and prior to obtaining the positioning configuration information, send a positioning session request via the transceiver to the location server.
Clause 27. The relay UE of any one of clauses 20-25 wherein the one or more processors are further configured to, prior to obtaining the positioning configuration information: receive a positioning session request via the transceiver from a remote UE; and send the positioning session request via the transceiver to the location server.
Clause 28. A location server for enabling a sidelink (SL) positioning session using paging transfer, the location server comprising: a transceiver; a memory; and one or more processors communicatively coupled with the transceiver and the memory, wherein the one or more processors are configured to: receive, via the transceiver from a relay user equipment (UE), positioning capability information of one or more remote UEs, wherein, for each remote UE of the one or more remote UEs, the positioning capability information is indicative of at least one capability of the respective remote UE for performing SL positioning; determine positioning configuration information for conducting the SL positioning session based at least in part on the positioning capability information; and send, via the transceiver to the relay UE, the positioning configuration information, wherein the relay UE sends the positioning configuration information in a paging request.
Clause 29. The location server of clause 28, wherein the one or more processors are further configured to, prior to receiving the positioning capability information, send a request to the relay UE from the location server for the positioning capability information.
Clause 30. The location server of any one of clauses 28-29 wherein the one or more processors are further configured to send the paging request in a paging search space for positioning.
Clause 31. An apparatus having means for performing the method of any one of clauses 1-16.
Clause 32. A non-transitory computer-readable medium storing instructions, the instructions comprising code for performing the method of any one of clauses 1-16.

What is claimed is:

1. A method at a relay user equipment (UE) of enabling a sidelink (SL) positioning session using paging transfer, the method comprising:
obtaining, at the relay UE, positioning capability information from one or more remote UEs, wherein, for each remote UE of the one or more remote UEs, the positioning capability information is indicative of at least one capability of the respective remote UE for performing SL positioning;
obtaining, at the relay UE, positioning configuration information for conducting the SL positioning session; and
sending, from the relay UE to the one or more remote UEs, the positioning configuration information, wherein the relay UE sends the positioning configuration information during one or more paging occasions (POs) of the one or more remote UEs.

2. The method of claim 1, further comprising storing the positioning capability information with the relay UE.

3. The method of claim 1, wherein a number of the one or more remote UEs is less than a predetermined maximum number of remote UEs for which the relay UE is configured to store positioning capability information.

4. The method of claim 1, further comprising sending, from the relay UE to a location server, the positioning capability information for the one or more remote UEs, wherein obtaining positioning configuration information comprises receiving the positioning configuration information from the location server.

5. The method of claim 4, wherein sending the positioning capability information is responsive to receiving a request, at the relay UE from the location server, for the positioning capability information.

6. The method of claim 4, wherein receiving the positioning configuration information from the location server comprises receiving the positioning configuration information in a paging request.

7. The method of claim 6, wherein the paging request is received in a paging search space for positioning.

8. The method of claim 7, wherein the paging search space for positioning is:
within an active bandwidth part (BWP) of the relay UE;
outside the active BWP of the relay UE but within the same component carrier (CC) of the active BWP of the relay UE; or
outside the active BWP of the relay UE and in a separate CC from the CC of the active BWP of the relay UE.

9. The method of claim 6, wherein the paging request comprises a positioning paging record and a positioning paging record list.

10. The method of claim 4, wherein the SL positioning session is to determine a location of the relay UE, and wherein the method further comprises:
determining at the relay UE to initiate the SL positioning session; and
prior to obtaining the positioning configuration information, sending a positioning session request from the relay UE to the location server.

11. The method of claim 4, wherein the SL positioning session is to determine a location of a particular remote UE of the one or more remote UEs, and wherein the method further comprises, prior to obtaining the positioning configuration information:
receiving a positioning session request at the relay UE from the particular remote UE; and
sending the positioning session request from the relay UE to the location server.

12. A method at a location server of enabling a sidelink (SL) positioning session using paging transfer, the method comprising:
receiving, at the location server from a relay user equipment (UE), positioning capability information of one or more remote UEs, wherein, for each remote UE of the one or more remote UEs, the positioning capability information is indicative of at least one capability of the respective remote UE for performing SL positioning;
determining positioning configuration information for conducting the SL positioning session based at least in part on the positioning capability information; and
sending, to the relay UE from the location server, the positioning configuration information, wherein the location server sends the positioning configuration information in a paging request.

13. The method of claim 12, further comprising, prior to receiving the positioning capability information, send a request to the relay UE from the location server for the positioning capability information.

14. The method of claim 12, wherein the paging request is sent in a paging search space for positioning.

15. The method of claim 14, wherein the paging search space for positioning is:
within an active bandwidth part (BWP) of the relay UE;
outside the active BWP of the relay UE but within the same component carrier (CC) of the active BWP of the relay UE; or
outside the active BWP of the relay UE and in a separate CC from the CC of the active BWP of the relay UE.

16. The method of claim 12, wherein the paging request comprises a positioning paging record and a positioning paging record list.

17. A relay user equipment (UE) for enabling a sidelink (SL) positioning session using paging transfer, the relay UE comprising:
a transceiver;
a memory; and
one or more processors communicatively coupled with the transceiver and the memory, wherein the one or more processors are configured to:
obtain, via the transceiver, positioning capability information from one or more remote UEs, wherein, for each remote UE of the one or more remote UEs, the positioning capability information is indicative of at least one capability of the respective remote UE for performing SL positioning;
obtain positioning configuration information for conducting the SL positioning session; and
send, via the transceiver to the one or more remote UEs, the positioning configuration information, wherein the relay UE sends the positioning configuration information during one or more paging occasions (POs) of the one or more remote UEs.

18. The relay UE of claim 17, wherein the one or more processors are further configured to store the positioning capability information in the memory.

19. The relay UE of claim 17, wherein a number of the one or more remote UEs is less than a predetermined maximum number of remote UEs for which the relay UE is configured to store positioning capability information.

20. The relay UE of claim 17, wherein the one or more processors are further configured to send, via the transceiver to a location server, the positioning capability information for the one or more remote UEs, and wherein, to obtain the positioning configuration information, the one or more processors are configured to receive the positioning configuration information from the location server.

21. The relay UE of claim 20, wherein the one or more processors are configured to send the positioning capability information responsive to receiving a request, from the location server, for the positioning capability information.

22. The relay UE of claim 20, wherein, to receive the positioning configuration information from the location server, the one or more processors are configured to receive the positioning configuration information in a paging request.

23. The relay UE of claim 22, wherein the one or more processors are configured to receive the paging request received in a paging search space for positioning.

24. The relay UE of claim 23, wherein the one or more processors are configured to receive the paging search space for positioning:
within an active bandwidth part (BWP) of the relay UE;
outside the active BWP of the relay UE but within the same component carrier (CC) of the active BWP of the relay UE; or
outside the active BWP of the relay UE and in a separate CC from the CC of the active BWP of the relay UE.

25. The relay UE of claim 22, wherein the one or more processors are configured to receive, in the paging request, a positioning paging record and a positioning paging record list.

26. The relay UE of claim 20, wherein the one or more processors are further configured to:
determine to initiate the SL positioning session; and
prior to obtaining the positioning configuration information, send a positioning session request via the transceiver to the location server.

27. The relay UE of claim 20, wherein the one or more processors are further configured to, prior to obtaining the positioning configuration information:
receive a positioning session request via the transceiver from a remote UE; and
send the positioning session request via the transceiver to the location server.

28. A location server for enabling a sidelink (SL) positioning session using paging transfer, the location server comprising:
a transceiver;
a memory; and
one or more processors communicatively coupled with the transceiver and the memory, wherein the one or more processors are configured to:
receive, via the transceiver from a relay user equipment (UE), positioning capability information of one or more remote UEs, wherein, for each remote UE of the one or more remote UEs, the positioning capability information is indicative of at least one capability of the respective remote UE for performing SL positioning;
determine positioning configuration information for conducting the SL positioning session based at least in part on the positioning capability information; and
send, via the transceiver to the relay UE, the positioning configuration information, wherein the relay UE sends the positioning configuration information in a paging request.

29. The location server of claim 28, wherein the one or more processors are further configured to, prior to receiving the positioning capability information, send a request to the relay UE from the location server for the positioning capability information.

30. The location server of claim 28, wherein the one or more processors are further configured to send the paging request in a paging search space for positioning.
